(19) United States
(12) Patent Application Publication
(10) Pub. No.: US 2007/0110431 A1
(43) Pub. Date: May 17, 2007

(54) Device for non-invasive cleaning of the light sensor of digital single lens reflex cameras

(75) Inventor: Biddle W. Worthington, New York, NY (US)

Correspondence Address: Mr.Biddle W Worthington;Apt. 28K, 185 East 85th Street, New York, NY, 10028-2143, US

(73) Assignee: Biddle W Worthington, New York, NY (US)

(21) Appl. No.: 11/164,293

(22) Filed: Nov. 17, 2005

(51) Int. Cl. G03B 19/00

(52) U.S. Cl. 396/429

(57) ABSTRACT

Rapid growth in the use of digital SLR cameras has created a need for an easy way to clean the light sensors, the heart of the digital camera. All SLRs are designed with interchangeable lenses. The process of changing lenses momentarily exposes the inside of the camera to air borne debris and dust. Inevitably, some of this dust settles on the light sensor, leaving a visible mark on each subsequent picture. The Sensorclean device described here provides a means to firmly and safely mount the tip of a hand operated air blower approximately 2 mm from the surface of the delicate light sensor. The resulting jet of high velocity air removes all visible dust from the light sensor. The Sensorclean device is completely non-invasive in the sense that no contact with the light sensor is required.

Definition List 1

| Term | Definition |
|---|---|
| SLR | Single lens reflex camera |

Definition List 2

| Term | Definition |
|---|---|
| Sensorclean | The device being described here |

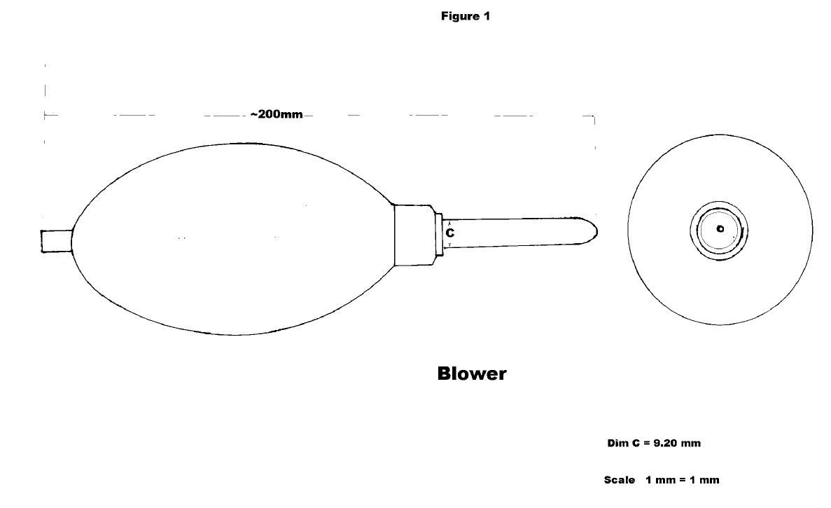

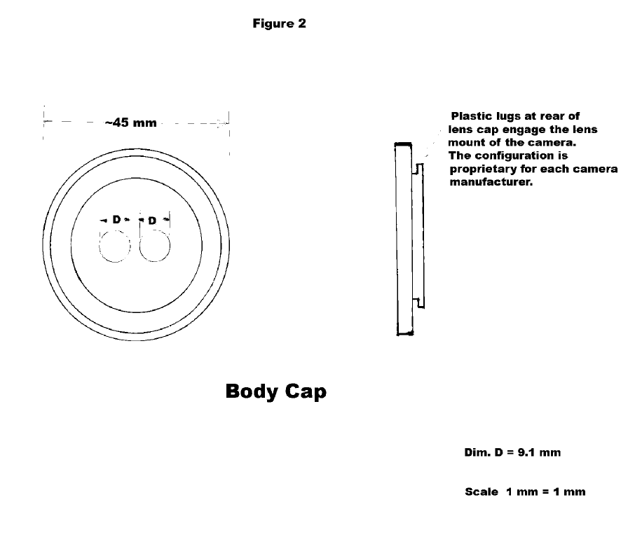

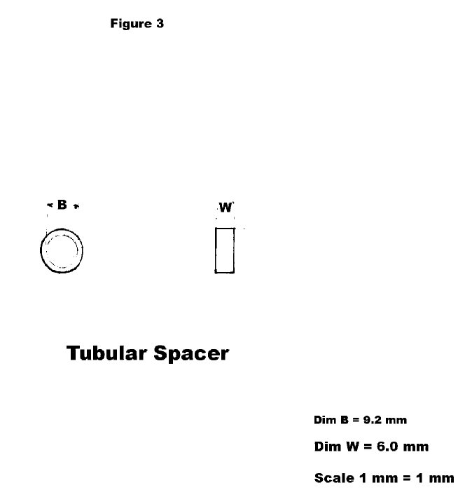

The device (hereafter called “Sensorclean”) has three parts:
(1) A hand activated air blower with a tapered tubular nozzle, shown in FIG. 1. The blower bulb is made of flexible rubber, and the nozzle is made of a semi-rigid plastic. An off the shelf blower was used for the prototypes and will also be used in production. None of the air blower's dimensions are critical except that the diameter of the output nozzle (Dim. C) at its base must be 0.1 mm +/−0.02 mm greater then the diameter of the circular holes (Dim. D) in the body cap. This interference fit is necessary to hold the nozzle firmly in place, which ensures a high velocity air stream over the sensor.
(2) A circular plastic body cap, shown in FIG. 2 (varies by camera brand), that engages and covers the circular opening of the camera when the lens is removed. The lugs on the rear of the body cap mimic the configuration of the bayonet mount of the lens. The body cap used for the prototype is an off the shelf item that is readily available from several sources. The body cap has one or two holes drilled in it that are opposite the camera's light sensor. This patent application applies to both the one-hole (in the center of the body cap) and the multi-hole design. The two-hole version is considered superior because it covers a larger area and permits the ability to rotate the location of the air jet to deal with stubborn dust spots. The diameter of the holes (Dim. D) must be 0.1 mm +/−0.02 mm smaller than the blower nozzle diameter (Dim. C) at the base in order to hold the nozzle firmly in place when it is inserted.
(3) A small tubular spacer, shown in FIG. 3, that fits over the nozzle of the blower. The spacer is made of acrylic plastic. The width of the spacer (varies by camera brand) is precisely sized to locate the nozzle tip very close (approx. 2 mm) to the camera's sensor. For Nikon digital SLRs the width of the spacer (Dim. W) must be 6 mm +/−0.2 mm. The inside diameter of the tubular spacer (Dim. B) must be approximately 0.1 mm smaller than the diameter of the blower nozzle at the base. This will ensure a snug fit and still permit easy removal of the spacer. A different spacer will be required for each brand of camera. Both the spacer and the body cap must be changed when switching camera brands (e.g. Nikon to Canon).

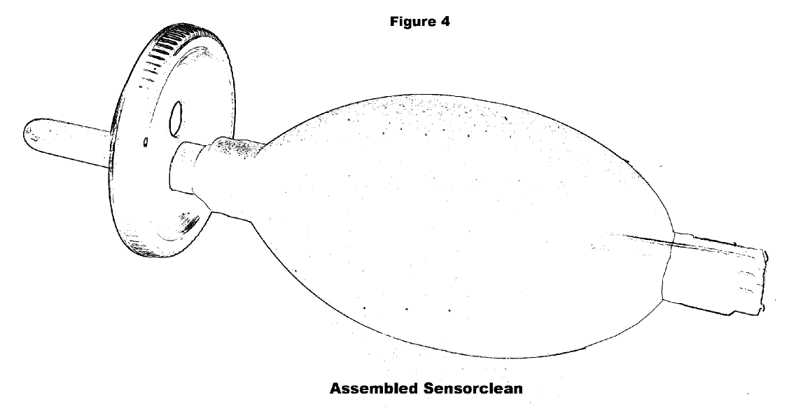

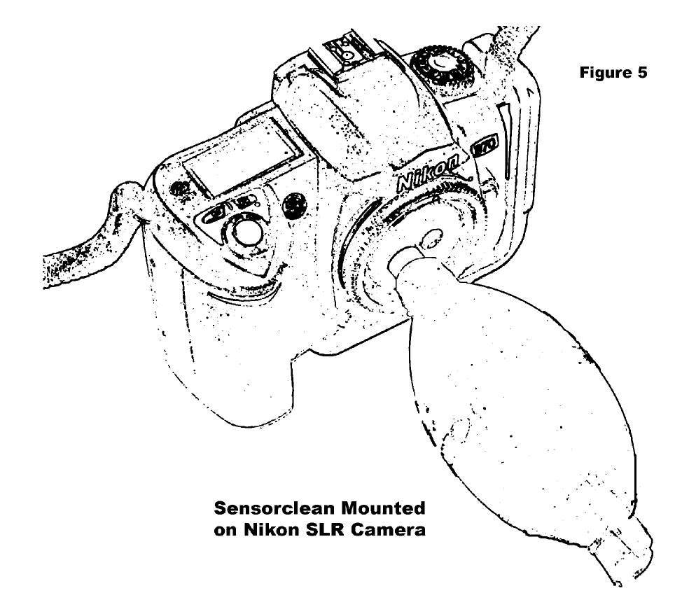

Sensorclean is assembled by first sliding the tubular spacer over the blower nozzle as far as it will go. Next the blower nozzle is inserted into one of the holes in the body cap as far as it will go (flush against the tubular spacer). An assembled Sensorclean is shown in FIG. 4. The camera is prepared for cleaning by removing the lens and activating the “mirror up” function. This exposes the light sensor. Sensorclean is now placed over the lens opening of the camera and mounted by rotating the cap in a counter clockwise direction. The mounting is identical to mounting a lens on the camera. The blower nozzle extends approximately 40 mm into the camera to within 2 mm of the sensor, but it touches nothing. The user now cleans the sensor by squeezing the blower a dozen or so times after which he repeats the operation for the other side of the sensor. The precise location of the nozzle tip (2 mm from the light sensor) insures that high velocity air, sufficient to remove all visible dust, hits the sensor. A drawing of a Sensorclean mounted and ready to clean a Nikon digital SLR is shown in FIG. 5.

What is claimed is:

1. A method of cleaning the light sensor of a digital SLR camera by firmly and precisely positioning the tip of an ordinary commercial hand air blower approximately 2 mm from the surface of the light sensor. Such firm and precise positioning of the blower nozzle tip is achieved by inserting the nozzle of the blower through a precisely sized center hole in an ordinary camera body cap, which has been mounted on the SLR camera. Hand squeezing said blower produces a high velocity jet of air at such close proximity to the light sensor that virtually all accumulated dust and debris are blown away and dissipated. This cleaning process is non-invasive in the sense that there is no physical contact with the light sensor.

2. The method of claim 1 further comprising the step of the addition of multiple and/or off-center holes in the body cap. This expands the area of the light sensor that is covered by the air jets, and permits rotation of the body cap so that the air jets may be more precisely located directly over stubborn dust particles.
